(19) United States
(12) Patent Application Publication
(10) Pub. No.: US 2018/0315125 A1
(43) Pub. Date: Nov. 1, 2018

(54) SYSTEMS AND METHODS FOR DYNAMIC RISK MODELING TAGGING

(71) Applicant: JPMorgan Chase Bank, N.A., New York, NY (US)

(72) Inventors: Kent Jiatian Zheng, London (GB); Yingke Wang, London (GB); Stuart James O'Neill, London (GB)

(21) Appl. No.: 15/964,575

(22) Filed: Apr. 27, 2018

Related U.S. Application Data
(60) Provisional application No. 62/491,601, filed on Apr. 28, 2017.

(51) Int. Cl. G06Q 40/06; G06N 99/00

(52) U.S. Cl. CPC G06Q 40/06; G06N 99/005

(57) ABSTRACT

Systems and methods for dynamic risk modeling tagging are disclosed. In one embodiment, in an information processing apparatus comprising at least one computer processor, a method for dynamic risk modeling tagging may include: (1) defining a dynamic tagging framework comprising plurality of portfolio tags; (2) receiving data for a holding from at least one data source; (3) dynamically associating at least one of the portfolio tags in the dynamic tagging framework with the holding; (4) providing the data and the at least one portfolio tag to at least one engine; (5) providing the outputs of the at least one engine to a metric database; (6) dynamically linking the tagging framework to the metric database; and (7) generating at least one report. The at least one portfolio tag and the data are dynamically linked.

### RELATED APPLICATIONS

The present application claims priority to U.S. Provisional Patent Application Ser. No. 62/491,601 filed Apr. 28, 2017, the disclosure of which is hereby incorporated, by reference, in its entirety.

### BACKGROUND OF THE INVENTION

### 1. Field of the Invention

Embodiments of the present invention generally relate to systems and methods for dynamic risk modeling tagging.

### 2. Description of the Related Art

Tagging is the process of assigning labels to holdings within a portfolio such that portfolio holdings may be aggregated into sub-portfolios. Portfolio holdings may be assigned more than one label, which allows the same holding to be grouped into multiple sub-portfolios. Typically, these labels will seek to group portfolio holdings with similar attributes (type of instrument, type of asset class, geographical region etc.) but they may also be used to apply a subjective grouping (reason for dealing, strategy, macroeconomic driver etc.).

### SUMMARY OF THE INVENTION

Systems and methods for dynamic risk modeling tagging are disclosed. In one embodiment, in an information processing apparatus comprising at least one computer processor, a method for dynamic risk modeling tagging may include: (1) defining a dynamic tagging framework comprising plurality of portfolio tags; (2) receiving data for a holding from at least one data source; (3) dynamically associating at least one of the portfolio tags in the dynamic tagging framework with the holding; (4) providing the data and the at least one portfolio tag to at least one engine; (5) providing the outputs of the at least one engine to a metric database; (6) dynamically linking the tagging framework to the metric database; and (7) generating at least one report. The at least one portfolio tag and the data are dynamically linked.

In one embodiment, the method may further include splitting the holding into a plurality of sub-holdings based on the at least one portfolio tags associated with the holding.

In one embodiment, the method may further include applying an alternate tagging framework to the holding.

In one embodiment, the plurality of portfolio tags may be organized into a hierarchy.

In one embodiment, at least one of the plurality of portfolio tags may be associated with the portfolio position using machine learning.

In one embodiment, the data source may be an external data source.

In one embodiment, data may include static information about the holding, dynamic information about the holding, dynamic statistical attributes for the holding, etc.

In one embodiment, the at least one portfolio tag may be associated with a static attribute for the holding, a dynamic statistical attribute for the holding, a dynamic attribute for the holding based on a portfolio strategy, a dynamic attribute for the holding identified by machine learning, etc. In one embodiment, the machine learning may be based on correlation clustering.

In one embodiment, the metric database may include one or more of a P&L metric database, a positioning metric database, and a risk metric database.

In one embodiment, the engine may include one or more of a performance engine, a positioning engine, and a risk engine.

In embodiments, a portfolio of holdings may be tagged to express the portfolio manager's approach to investment and portfolio construction. The tags aggregate portfolio holdings together into sub-portfolios, such that the holdings in each sub-portfolio share some kind of commonality (e.g., in terms of static attributes, risk and return drivers, or manager-imposed classifications). As such, the tagging framework imposes a quantitative structure within the portfolio, and this structure should align with the investment process as followed by the portfolio manager. This process is dynamic, flexible, and expandable to represent investment processes and to allow the tagging framework to evolve as the portfolio evolves and the market environment changes.

In embodiments, the dynamic tagging framework may have three elements. The first is to create a tagging framework based upon tags that may be dynamically managed on-the-fly. For example, tags may be changed, edited, and restructured to create maximum flexibility such that the tagging framework is able to represent the current portfolio construction and current market environment as fully as possible and in as timely a manner as possible. This is fundamentally different from traditional static tagging, in which the tags are typically defined by static attributes of the underlying instruments, do not change throughout the life of the holding in the portfolio, and offer limited granularity.

The next element is to create a highly flexible framework such that there is no limit to either the number of tagging levels that may be defined or the number of tags that may be utilized within each tagging level. For example, the tagging levels may either be independent of each other, or may possess a dependency (e.g., a hierarchical, nested structure). The framework may accommodate both options for maximum flexibility.

This third element is to bind the tags “dynamically” to the underlying performance data, positioning data and risk data that is generated daily within the investment process. The use of dynamic binding has at least two advantages: (1) the underlying performance, positioning or risk data may be dynamically reconfigured using any of the tagging levels to analyze and manipulate the data on-demand, so the underlying data need be stored once—the tagging framework does all the hard work when retrieving the data and processing it as required. In contrast, traditional tagging statically bind the tags into the underlying data, and the configuration of the underlying data is fixed; (2) the dynamic linkage of the tags to the underlying data allows the tagging framework to be modified and changed, both historically and in real-time, and have those changes reflected immediately in how the underlying data is reconfigured. The underlying data, however, does not change, only the tags that are applied. This means that historical data can be automatically restated under new tagging frameworks that were not in existence at the time the historical data was created, and any aspect of the tagging framework may be expanded and amended as required, without limit.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for dynamic risk modeling tagging according to one embodiment;

FIGS. 2A, 2B, and 2C depict exemplary conceptual database structures according to embodiments; and

FIG. 3 depicts a method for dynamic risk modeling tagging according to one embodiment;

### DETAILED DESCRIPTION OF PREFERRED EMBODIMENTS

Systems and methods for dynamic risk modeling tagging are disclosed.

Embodiments disclosed herein use tags to aggregate various positions using common factors/characteristics into sub-portfolios. Tagging may be done at multiple levels, including, for example, by geographical region, currency, country, sector, traditional/sophisticated, asset class (at various levels of detail), fund sleeve (for those funds in a sleeve structure), instrument type, strategy, equity strategy, strategy group, macroeconomic theme, etc.

In embodiments, the tags may be either static or dynamic tags, and combinations of the two may be used to create new tagging levels. The flexibility and breadth of these tags allows performance/risk to be analyzed across multiple dimensions. Indeed, a global objective across the risk and performance infrastructure is to align the performance data with positional risk metrics (simple metrics such as delta, duration, net notional, gross notional, etc.) and portfolio risk metrics (ex-ante volatility, value at risk, conditional value at risk, correlation matrices, etc.). The consistent use of the dynamic tagging framework may achieve this objective; the dynamic tagging connects everything together.

At a most basic level, each position may be considered as a single tagged group of one holding. For example, a fund with 100 positions will have 100 “tagged” holdings at this base level. The fund positions may be tagged at multiple levels as listed above, thereby grouping similar fund holdings together according to the various risk dimensions. The tagging levels may or may not have a hierarchy, and, in general, the fewer tagged sub-portfolios there are at any tagged level, the more high-level the analysis becomes. At the highest level of tagging, the fund may be considered to be a single portfolio containing all 100 holdings.

The tagging process may group holdings having similar characteristics or common factors; thus, one may be more confident of the correlations between the holdings in a sub-portfolio as compared to the correlations between the sub-portfolios themselves. One may also expect these correlations to be more stable through time. In essence, more weight may be placed on “higher quality” correlation statistics, and less weight may be placed on “lower quality,” or spurious, correlation statistics. This may lead to higher quality risk analysis.

In embodiments, each tagging level may take account of a different degree of diversification: minimum diversification at the lower levels with many tagged sub-portfolios, and progressively higher degrees of diversification at the higher levels, with fewer sub-portfolios. At the fund level, all diversification available within the portfolio may be accounted for.

Within each tagging level, each sub-portfolio's contribution to the risk may be assessed. At each tagged level, the percentage contributions to risk sum to 100%.

The disclosed dynamic tagging framework may address issues such as how an existing holding contributes to the risk profile of the portfolio (or conversely how does closing an existing position affect the risk profile of the portfolio); how changing the weight of an existing holding affects the risk profile of the portfolio; how adding a new position affect the risk profile of the portfolio, etc. not only at the portfolio level, but also at each and every level defined within the tagging framework. The tagging framework facilitates the observation of changes in a risk profile from portfolio changes as they cascade through the tagging framework. This is a very extensive and thorough way of assessing potential changes in portfolio construction.

Embodiments provide some or all of the following advantages and features: In embodiments, the added flexibility of the dynamic tagging allows Multi-Asset Solutions (MAS) teams to create a far richer model of the portfolios they run when compared to traditional approaches and is fundamentally different from traditional holdings-based analysis, which typically relies on static data only. MAS teams often require a more sophisticated set of tools than single asset class managers (e.g., equity, fixed income, currency etc.). MAS is unique in that it utilizes an investment approach in which performance and risk analytics are aligned to Macro Theme/Strategy Group/Strategy dimensions (among others) with a quantitative assessment of risk and performance for the different strategies. This is in contrast to most tagging frameworks, in which a single strategy/tag is enforced across the lifetime of a position.

Embodiments facilitate the creation and aggregation of detailed performance records to disaggregate performance at regular pricing points, such as close of business (COB), start of business (SOB), and NAV (net asset value cut-off). Embodiments allow detailed yet consistent time series of daily data to be aggregated over multiple pricing points building up a rich data set of ex-post performance data for subsequent performance/risk analysis.

In embodiments, the tagging framework is highly flexible/configurable, and tagging levels may be added or deleted as necessary and/or desired. New tagging levels may be created on-the-fly, for example, by combining existing tagging levels (e.g., to provide more granularity). In embodiments, there may not be an upper limit on the number of tagging levels that may exist, or on the number of tags that may be utilized within each tagging level. The tagging may support a fully automated tagging processes, a fully manual tagging processes, or a combination of the two. For example, machine learning and/or artificial intelligence may be used in the tagging process.

Tagging levels may have a hierarchical relationship to some/all of the other tagging levels, or they may be independent of each other. The tags may be static tags, dynamic tags, or a combination of the two.

In embodiments, the dynamic nature of the tagging framework allows portfolio managers to adjust the tagging framework applied to the portfolio holdings in real-time. This presents the fullest possible representation of the investment process within the portfolio management infrastructure at all points in time, and allows this representation to be updated as and when the portfolio structure changes. This is in contrast to traditional tagging frameworks, which generally impose static tags on portfolio holdings for the duration of their lifetime in a portfolio, and do not allow an existing portfolio holding to be “retagged” if its purpose within the portfolio has changed. The dynamic ability greatly simplifies the management of a tagging framework and allows for a much more detailed historical record of the structure of the portfolio in question.

In embodiments, dynamic tagging may allow portfolio managers to refine the tagging framework to take account of a changing macroeconomic environment. For example, a particular portfolio might be considered rather static and have a low annual turnover, but it still operates in a macroeconomic environment that is in constant flux. In embodiments, the dynamic tagging framework allows for the real-time adjustment of tags used to signify the macroeconomic sensitivities/drivers of the portfolio's risk and performance.

For example, a European government bond's performance might be driven most of the time by interest rate movements of the issuing country, but in times of market stress its performance may become largely determined by movements in interest rates of the United States. The dynamic tagging framework can capture these evolving drivers in real-time.

In embodiments, the dynamic nature of the tagging framework may provide the ability to revise a historical track record/risk analysis because the tags are not statically bound to the underlying performance or risk data. This means that a tagging framework associated to a performance track record may be edited after the fact (possibly years after the fact), and the performance data will realign automatically via the dynamic binding. This allows the dynamic tagging framework to evolve and enhance through time (adding tagging levels, adding new tags) and the historical performance and risk track record can adjust automatically to the changing framework.

In embodiments, the process by which the tags are entered and edited into the system is flexible. Tags may be added to portfolio holdings automatically based on static data attributes of the holdings themselves (e.g., asset class, country of domicile, currency, instrument type, geographical region of operation, etc.). In another embodiment, tags may be added and/or managed dynamically by investment managers via, for example, a graphical user interface (GUI). In another embodiment, automated dynamic tagging may be utilized in which the assignment of tags may be the result of machine learning, artificial intelligence, and/or correlation clustering-type analysis on either the current portfolio or the existing historical record of tags applied to the fund in the past. In still another embodiment, a combination of two or three methods may be used

In embodiments, the dynamic tagging system may allow dynamic use of the concept of “splits” to allocate performance and risk of a single holding across multiple strategies in the same portfolio. This may be used because multiple contracts of the same derivative, or shares of the same stock, for example, are typically shown on a single line in a typical portfolio management system even though the component parts that aggregate up to the single line holding may have been traded for differing reasons. The use of a split allows this single line to be disaggregated into the underlying strategies it relates to, and for the performance and risk to be disaggregated into those same strategies. In a rapidly changing portfolio, the dynamic management of these splits may retain accurate and representative performance and risk data.

In embodiments, the dynamic tagging system may incorporate internal checks to test and/or warn the portfolio managers of missing tags, inconsistent tags, inconsistent splits, or other general issues with the tagging framework that may require the attention of the portfolio manager. Issues may be flagged (e.g., in real-time) to the portfolio managers for remediation. Comprehensive and rapid consistency checks are impossible for human operators to perform accurately in such a high-dimensional tagging framework due to the number of pairwise combinations possible with the tags/tagging levels.

In embodiments, the tagging framework, used alongside an efficient portfolio management platform, may ensure that clean and systematic analytics are provided to the portfolio managers (e.g., in real-time). Further, the efficiencies gained from the dynamic tagging linkages may lead to the reduction or elimination of existing manual processes and manual effort when handling performance and risk data for client reporting purposes.

In embodiments, the dynamic nature of the tagging framework is an element of the provision of live performance and loss (P&L) reports, where “live” refers to those reports that are produced on demand and use live market prices, rather than that performance captured at regular specified times (e.g., COB, SOB, NAV cuts). The combination of the detailed dynamic tagging framework with the live performance data provides a powerful tool for the real-time management of sophisticated multi-asset funds, particularly those that trade a high proportion of derivative strategies, a high number of individual strategies or adjust the portfolio construction on a medium to high frequency basis. Detailed tagging may provide detailed information about how the portfolio is responding to real-time market events such as major data releases, central bank rate announcements, equity market sell-offs etc. and aids the portfolio managers in understanding their portfolios at deeper levels.

In embodiments, detailed risk and performance data lends itself to sophisticated and advanced visualization techniques in the graphical user interface (GUI). Data may also be disseminated via automated and on-demand emails, automated and on-demand PDF/Microsoft Excel reports, etc.

In embodiments, the dynamic tagging framework may be paired with pivot data/table functionality to leverage the multi-dimensional power of pivot tables with the multi-dimensional performance and risk data. The combination may be customizable and very flexible, and may enable rapid analysis or manipulation of performance/risk data in contrast to more rigid performance and risk reports that have a specified and non-configurable structure.

In embodiments, the dynamic tagging framework may feed into the automated risk analytics that are produced daily. A throttle may be placed on the risk analytics such that the process may only initiate if all portfolio holdings are tagged and the tagging has been confirmed as internally consistent. Once the process is initiated, the tags may be used to define the data structure that goes into the risk models (for example, parametric, historical, or Monte Carlo methodologies). The result may be a rich dataset of either ex-ante or ex-post risk statistics (e.g., volatility, marginal volatility, incremental volatility, VaR, CVaR, correlation matrices, etc.) displayed at all tags within all tagging levels. The dynamic tagging framework may be used to disaggregate a single ex-ante or ex-post risk number (e.g., portfolio volatility, VaR, CVaR, etc.) into its underlying components, as specified by the tagging framework (applied to the portfolio) and may provide a rich view of portfolio risk on a total return fund (i.e. a fund without an asset-based benchmark).

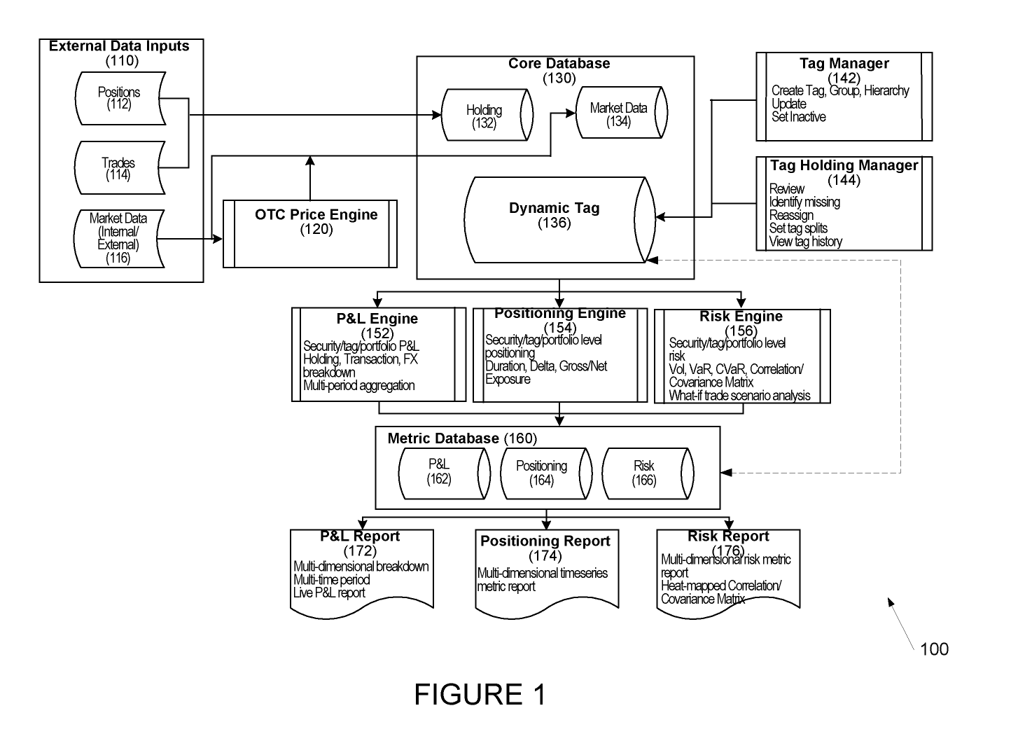

Referring to FIG. 1, a system for dynamic risk modeling tagging is disclosed according to one embodiment. System 100 may include external data inputs 110, which may provide market data for securities. In one embodiment, external data inputs 110 may include positions, 112, trades 114, and market data 116 (e.g., internal and/or external data). Data from other data sources may be received as is necessary and/or desired.

In one embodiment, data may also be received from internal data sources (not shown).

Data that may be received may include, for example, static information about each portfolio holding (e.g., instrument type, country of risk, currency, asset class, units of denomination etc.), internal models (e.g., those that provide dynamic information about each portfolio holding, such as risk model loadings/betas to market risk factors, trading model loadings/betas to the risk premiums, etc.), external pricing databases (e.g., Bloomberg, Reuters, DataStream, etc.), internal pricing databases (e.g., those that contain non-public proprietary data), and internal portfolio databases that maintain real time portfolio holdings & transactions data.

System 100 may further include OTC (over-the-counter) price engine 120 that may compute prices for those portfolio holdings for which a price is not readily observable in the market. For example, these may be derivatives that require multiple parameters be input into a pricing model to derive a value for the derivative contract.

System 100 may further include core database 130, which may include holding database 132, market data database 134, and dynamic tagging database 136. Holding database 132 may store information on positions and trades for holdings that may be received from external data inputs 110 (e.g., positions 112 and trades 114). Market data database 134 may receive and store market data, such as pricing data, from external data inputs 110 (e.g., market data 116) and OTC price engine 120). Dynamic tagging framework 136 may store tags received from tag manager 142, which may specify a manner in which holdings are tagged.

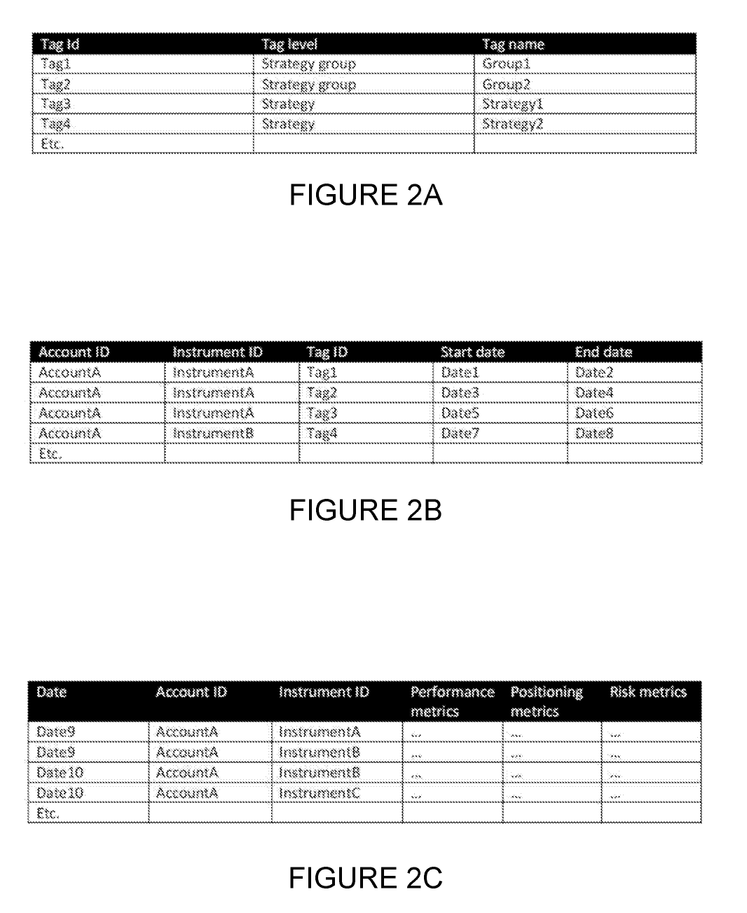

FIG. 2A depicts a conceptual database structure for tag manager according to one embodiment.

In one embodiment, tag holding manager 144 may provide a tag management tool and tag repository for the tags which may be used in the dynamic tagging framework. In one embodiment, new tags/tagging levels may be defined here and may then be applied within the dynamic tagging framework. Likewise, any tags no longer used may be deprecated (so their use is restricted) but not deleted, so that they may be retained for potential future usage.

In one embodiment, tag holding manager may further include logic for automated consistency checking, and the ability to define the tag splits of individual positions.

Referring again to FIG. 1, in one embodiment, a plurality of engines (e.g., performance or P&L engine 150, positioning engine 152, and risk engine 154 may receive data from core database 130. Engines 150, 152, and 154 may produce the performance, positional, and risk data to which the dynamic tags may be dynamically bound. The data may be produced by combining the holdings data from holding database 132 and the market data from market data database 134. Engines 150, 152, and 154 may not bind the tags to the underlying data; a dynamic link remains between the dynamic tagging framework 136 and metric database 160.

Referring to FIG. 2B, an exemplary conceptual database structure for dynamic tagging framework 136 is provided according to one embodiment. In FIG. 2B, the start date and the end date may be used to define the historical period during which the tag is applied to the specified Instrument ID. These dates may be edited whenever tags are added, deleted, or modified. As the tagging framework evolves through time, the tags applied to each Instrument ID may change. These dates define which tags are to be applied to the specified Instrument ID at which points in the historical record stored in metric database 160.

In one embodiment, the Instrument Id provides the dynamic linkage between dynamic tagging framework 136 and metric database 160.

Referring again to FIG. 1, metric database 160, which may include databases storing P&L metrics 162, positioning metrics 164, and risk metrics 166, may be provided and may store the performance, positional and risk data as computed by performance engine 150, positioning engine 152, and risk engine 154, respectively. Dynamic tags may be linked dynamically to these databases so that if the dynamic tags change, the configuration of this performance, positional and risk data may also change.

For example, when the data is retrieved from metric databases 160, it may be retrieved alongside the tagging framework via this dynamic linkage. Metric databases 160 may be repositories that do not act on the data in any way. Instead, a database programming language (associated to the underlying database) may manipulate the retrieved data, and may splice the metric data with the tag data. This process may organize the metric data along the dimensions as supplied by the tagging framework so that it can be delivered to the reporting stage pre-configured. The reports are a transmission mechanism for data that has already been configured.

Referring to FIG. 2C, an exemplary conceptual database structure of metric database 160 is provided according to one embodiment. Whenever metric database 160 is queried for reporting purposes, the dynamic tags may be queried simultaneously (via Instrument ID) and are used to configure the metric data prior to exporting to reports 172, 174, and 176.

Referring again to FIG. 1, system 100 may further include reporting, such as P&L report 172, positioning report 174, and risk report 176. In one embodiment, each report may provide multi-dimensional reporting for the topic. For example, P&L report 172 may provide a multi-dimensional breakdown for one or more time period. It may further provide a live P&L report. Positioning report 174 may provide a multi-dimensional time series metric report. Risk report 176 may provide a multi-dimensional risk metric report, and may provide a heat-mapped correlation/covariance matrix.

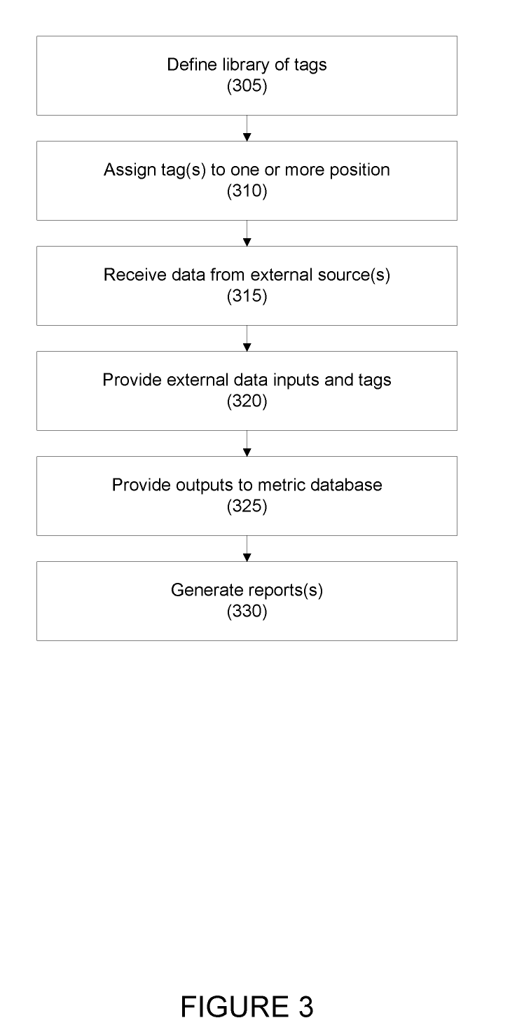

Referring to FIG. 3, a method for dynamic risk modeling tagging is disclosed according to one embodiment.

In step 305, a library of tags may be defined and/or created. In one embodiment, the tags may be created by a tag manager, by an automated process, etc. In one embodiment, the tags may be grouped, organized into a hierarchy, etc.

The tags may represent one or more concept, including, for example, the static attributes of a portfolio holding (e.g., asset class, country, currency, instrument type, etc.), the dynamic statistical attributes of a portfolio holding (e.g., correlation/beta/co-integration to market risk factors as defined by a multi-dimensional market risk model, etc.), the dynamic attributes of a portfolio holding (e.g., subjective tags applied by the investment managers such as “strategy,” “strategy group,” “macroeconomic driver,” etc. that may be used to define the manager's investment process within the quantitative portfolio management infrastructure; the dynamic attributes of a portfolio holding as defined by “smart” algorithms such as machine learning, artificial intelligence, big data analysis, correlation clustering, etc. to assign tags automatically based on the dynamic output of such algorithms; the dynamic attributes of a portfolio holding as defined by agencies external to the organization, such as ESG (Environmental, Social and Governance) factor loadings, carbon footprints, sustainability indices, etc.

In step 310, the tags may be assigned to one or more positions. The tags may be assigned manually, automatically using machine learning, or by a combination.

For example, in one embodiment, machine learning and/or artificial intelligence may be applied to the historical track record of portfolio holdings to train algorithms based upon the portfolio manager's previous tagging decisions. The algorithm may then run automatically to tag, or to suggest tags, additions to the portfolio. The portfolio manager may accept the tags or suggested tags, or may override the tags or suggested tags. With sufficient training, such an artificial algorithm may automate fully the dynamic tagging process. Thus, automated tagging may be applied across large numbers of portfolios, too numerous to be managed by accurately and efficiently by human operators.

In one embodiment, correlation clustering analysis may be applied to the portfolio holdings to suggest the tags to be used for new holdings based upon how similar (i.e., clustered) they are with respect to existing tagged holdings. In addition, clustering may be used to check tagging for consistency, and may flag inconsistent tags on holdings that share statistical attributes, rather than static attributes. In one embodiment, the clustering analysis is a quantitative algorithm that cannot be performed manually and so could only be achieved by integrating the clustering logic directly into the dynamic tagging framework.

In step 315, data may be received from one or more external data sources, such as positions, trades, and market data (internal and/or external).

In step 320, the external data inputs and the tags may be provided to one or more engine, such as a P&L engine, a positioning engine, and a risk engine.

In step 325, the outputs of the engine(s) may be provided to a metric database, and, in step 330, one or more report(s) may be generated. For example, a P&L report, a positioning report, and a risk report may be generated.

In one embodiment, should tags change, be added, deleted, etc., risk data (and other data) may be restated historically, and on-demand, when the tagging framework is either changed or enhanced. The dynamic nature of the tagging framework allows the risk analysis data to be reconstituted as a result of changing the tagging framework, rather than just merely forcing a recalculation.

In embodiments, there may be no limit to the disaggregation within the portfolios, and single portfolio holdings may be split into multiple underlying sub-holdings via the “splitting” logic. This means an infinite number of sub-portfolios may be created as is necessary and/or desired. Such an approach may find usage inside multi-factor risk models in which portfolio holdings have “loadings” (mathematically: “betas”) computed against thousands of market risk factors. Mapping these loadings into a portfolio is clearly not something a human being could accomplish, but the dynamic tagging framework described herein may take those loadings and automatically generate the requisite number of dynamic tags and splits necessary to represent multi factor loadings within the tagging framework.

The dynamic binding logic used within the dynamic tagging framework may readily allow the testing of alternative tagging frameworks; should a portfolio manager wish to apply a new tagging hierarchy, the portfolio manager may take advantage of the dynamic tagging to see what the new tagging framework implies about the historical ex-post performance and risk data. A new disaggregation may be applied and compared to the current disaggregation, but because the linkages are dynamic, the underlying data has not changed—it has merely been reconfigured—and the previous tagging choices can be reverted to without difficulty. As such, the dynamic binding allows the portfolio manager to carry out rapid “what if” analysis of new tags and back-testing of new tagging methodologies, in particular those produced by machine learning/artificial intelligence in which the possibilities the algorithms may suggest are simply too numerous to be input and tested manually by human operators.

In one embodiment, automated warnings may be placed used with the engines to highlight excessive concentrations of risk and/or performance in one or more tagged groups. This may assist in flagging, in real-time, failures of portfolio diversification that may need to be addressed within the portfolio manager's investment process. For example, there are multiple correlations embedded within any one portfolio, and the number of unique correlations between portfolio holdings is a non-linear function of the number of holdings (e.g., a portfolio with 10 assets has 45 unique correlations, but a portfolio with 100 assets has 4950 unique correlations; i.e. the number of correlations has not increased by 10-fold when going from a 10 asset portfolio to a 100 asset portfolio, instead the number of correlations has increased 110-fold). With dynamic tagging across multiple tagging levels, the effective number of portfolio holdings may increase dramatically and the total number of unique correlations will grow proportional to N*N, where N is the total number of tags utilized in the framework. It is impossible for human operators to check or even be aware such a huge number of correlations, but automated scanning of all tagged correlation matrices may achieve this. Doing so may then alert portfolio managers to excessively high correlations that are hidden at various tagged levels deep within the portfolio.

In one embodiment, automated methodologies may be used to monitor prevailing risk dynamics within the portfolio, and to compare these dynamics to previous episodes in which specific dynamics preceded specific profit or loss events. This may serve as an “early warning system” to alert the portfolio managers of a likely event. Examples of automated methodologies include regime/Markov switching models, machine learning/artificial intelligence, scoring models, and signal aggregation models.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for dynamic risk modeling tagging, comprising:
in an information processing apparatus comprising at least one computer processor:
defining a dynamic tagging framework comprising plurality of portfolio tags;
receiving data for a holding from at least one data source;
dynamically associating at least one of the portfolio tags in the dynamic tagging framework with the holding;
providing the data and the at least one portfolio tag to at least one engine;
providing the outputs of the at least one engine to a metric database;
dynamically linking the tagging framework to the metric database; and
generating at least one report;
wherein the at least one portfolio tag and the data are dynamically linked.

2. The method of claim 1, further comprising:
splitting the holding into a plurality of sub-holdings based on the at least one portfolio tags associated with the holding.

3. The method of claim 1, further comprising:
applying an alternate tagging framework to the holding.

4. The method of claim 1, wherein the plurality of portfolio tags are organized into a hierarchy.

5. The method of claim 1, wherein at least one of the plurality of portfolio tags is associated with the portfolio position using machine learning.

6. The method of claim 1, wherein the data source is an external data source.

7. The method of claim 1, wherein the data comprises static information about the holding.

8. The method of claim 1, wherein the data comprises dynamic information about the holding.

9. The method of claim 1, wherein the data comprises dynamic statistical attributes for the holding.

10. The method of claim 1, wherein the at least one portfolio tag is associated with a static attribute for the holding.

11. The method of claim 1, wherein the at least one portfolio tag is associated with a dynamic statistical attribute for the holding.

12. The method of claim 1, wherein the at least one portfolio tag is associated with a dynamic attribute for the holding based on a portfolio strategy.

13. The method of claim 1, wherein the at least one portfolio tag is associated with a dynamic attribute for the holding identified by machine learning.

14. The method of claim 13, wherein the machine learning comprises correlation clustering.

15. The method of claim 1, wherein the metric database comprises at least one of a P&L metric database, a positioning metric database, and a risk metric database.

16. The method of claim 1, wherein the engine comprises at least one of a performance engine, a positioning engine, and a risk engine.
